(19) United States
(12) Patent Application Publication
(10) Pub. No.: US 2004/0154749 A1
(43) Pub. Date: Aug. 12, 2004

(54) Label applicator

(76) Inventor: Clifford B. Rice, Ellington, CT (US)

Correspondence Address: Stephen P. Scuderi, Esq., McCormick, Paulding & Huber LLP, City Place II, 185 Asylum Street, Hartford, CT, 06103, US

(21) Appl. No.: 10/361,321

(22) Filed: Feb. 10, 2003

(51) Int. Cl. B32B 1/00

(52) U.S. Cl. 156/363; 156/384; 156/556; 156/566; 156/569

(57) ABSTRACT

A label applicator for applying labels to an article is presented. The labels are carried on an elongated web wound around a core to form a roll of labels. The label applicator includes a supply reel, a label removal device, a label application device, and a take-up reel all mounted to a frame. The supply reel has a mounting mechanism for releasably retaining the core of the roll, and a magnetic tension control mechanism for applying tension to the web as the web is unwound from the roll. The magnetic tension control mechanism has a housing with a magnet and a rotating generally disc shaped member mounted therein. The magnet emits a magnetic flux and the rotating generally disc shaped member conducts the magnetic flux to provide a tension force opposite to the direction of rotation of the roll as it is unwound on the supply reel.

### FIELD OF THE INVENTION

The present invention relates generally to label applicators and more particularly to a label applicator having a magnetic tension control mechanism for applying tension on a supply reel.

### BACKGROUND OF THE INVENTION

In a conventional label application process, a label applicator applies labels from a roll of labels to articles as the articles are advanced through an appropriate position at a labeling station. The label applicator typically includes a supply reel, a take-up reel, a label removal device, a label application device and a controller, all of which are mounted to a support frame. Conventional label applicators often also include a printer to print onto the labels before being applied to the article, in which case the label applicator is typically called a label printer/applicator.

The labels typically have one side coated with a pressure sensitive adhesive, and are carried on an elongated backing strip or web. The web and labels are wound around a core, e.g., a hollow cardboard cylinder, to form the roll of labels, which is mounted on the supply reel of the label applicator.

The label removal device typically includes a number of intermediate rollers, a peeler bar, an air bar and (in the case of a label printer/applicator) a printer. One of the intermediate rollers and/or the printer is generally driven by a drive motor to pull the web from the roll on the supply reel, through the printer, over a peeling edge of the peeler bar, and to the take-up reel. The peeling edge of the peeler bar sequentially removes the labels from the web as the web is bent around the peeler bar. In the case of a printer/applicator, the drive motor and the peeler bar are often incorporated into the printer itself. The air bar is generally located underneath the peeler bar and utilizes a blast of gas, e.g., air, through a single orifice to transfer the labels to the label application device. The waste web material, which is left after the labels have been removed, is re-wound by the take-up reel.

The label application device is designed for releasably retaining the labels from the label removal device and applying the labels to the article. A typical label removal device may include a piston assembly having a piston rod with a foot block mounted to one end. The foot block having a receiving face with a plurality of orifices through which vacuum pressure is applied to at least some of the orifices to releasably retain the labels thereon. The labels are generally transferred from the receiving face to the article by stamping the label onto the article or by blowing the label onto the article, or by a combination of both methods. The controller of the label applicator generally controls and monitors the functional parameters needed to effect the transfer of the labels from the web to the articles at the labeling station.

In order for the label applicator to function properly, the supply reel must have a tension control mechanism and a mounting mechanism. It is important that the tension control mechanism of the supply reel apply a relatively constant controlled tension, i.e., back torque, to the web as it is being pulled off of the roll of labels. Additionally the mounting mechanism of the supply reel must provide firm support against the inside diameter of the core (typically about 3 inches in diameter) of the roll of labels and securely lock the core so that it does not slip on the reel while it is being unwound. Moreover, the mounting mechanism must allow the roll to be easily mounted and released during a labeling application process.

However, in an attempt to solve the problems of tension control and mounting of the roll, prior art supply reels have obtained a complex design comprising many assembled components. These complex designs unnecessarily add to the cost and time of manufacturing the prior art label applicators.

Additionally, the large number of assembled components and moving parts increases the wear rate on the components and decreases reliability, which adds to the cost and frequency of repair of the label applicator.

The take-up reel of the label applicator requires a separate motor and tension control mechanism in order to properly take-up the slack of the waste web material and to re-wind it onto a separate core. The motor of prior art take-up reels has a motor shaft which indirectly drives a rotatable support shaft. The support shaft is offset from the motor shaft axis and is typically connected to the motor shaft through a combination of belts, pulleys and the like. A take-up reel shaft for rewinding the web thereon is concentrically mounted over the support shaft.

In an attempt to meet the dual requirements of motor drive and tension control, the take-up reel shaft of prior art take-up reels is not mounted in a fixed relation to the support shaft. That is, the motor will drive the support shaft at a given rotational speed, but as the web applies a back torque on the take-up reel shaft, it will slip relative to the support shaft and rotate at a different speed. Care must be taken not to adjust the tension control mechanism too tightly. If the take-up reel shaft exerts too much tension on the web it will be pulled through the printer too fast, thus causing the printing on the label to become smudged or deformed. As a result of these dual requirements, prior art take-up reels are complex in design and unnecessarily add to the cost of manufacture and maintenance of the prior art label applicators.

The air bars of the label applicator must smoothly transfer the labels from the peeler bar of the label removal device to the label application device. However, prior art air bars only have a single orifice from which a blast of pressurized gas (typically air), is directed at the partially peeled off label in order to push the label up to the receiving face of the label application device. Consequently, the air is not always evenly distributed over the bottom of the label, which can cause the labels to be wrinkled or miss-aligned during the transfer process.

The controller of the label applicator generally controls and monitors the functional parameters needed to print on the labels, to transfer the labels from the web to the label application device, and to transfer from the label application device to the article at the labeling station. This includes all timing requirements, positioning requirements and safety features. In label printer/applicators utilizing a piston assembly as a label application device, the controller must control the timing between the printing of a label and the extension of the piston rod to prevent false triggering and jams. Problematically in prior art controllers, the printer could finish printing a label and the prior art controller could then issue a command to transfer the label to the receiving face on the foot of the piston assembly. However, if the piston rod is not fully retracted before the transfer command is issued, the prior art printer/applicator could jam.

As mentioned earlier, the frame of the label applicator must support all of the components which make up the label applicator, including the optional printer in a label printer/applicator, and all the mechanisms needed to meet the tension control and drive requirements of the label application process. In order to support so many complex components and assemblies, prior art frames themselves have a complex design. Prior art frames include multiple supporting structures and are generally box shaped and bulky. Moreover, the prior art frames are adopted to have the tension control mechanism and the mounting mechanism of the supply reel mounted on only one side of the frame, thus further adding to the complexity of both frame and supply reel. This effects the cost of manufacture of the label applicator, as well as its durability. The added bulk and weight also effects shipping costs for the label applicator.

Accordingly, there is a need for an improved printer applicator with a simpler, more reliable and less costly design.

### SUMMARY OF THE INVENTION

The present invention offers advantages and alternatives over the prior art by providing a label applicator having a magnetic tension control mechanism for applying tension on a supply reel. The magnetic tension control mechanism simplifies the design and improves reliability of the label applicator.

These and other advantages are accomplished in an exemplary embodiment of the invention by providing a label applicator for applying labels to an article. The labels are carried on an elongated web wound around a core to form a roll of labels. The label applicator includes a supply reel, a label removal device, a label application device, and a take-up reel all mounted to a frame. The supply reel has a mounting mechanism for releasably retaining the core of the roll, and a magnetic tension control mechanism for applying tension to the web as the web is unwound from the roll. The magnetic tension control mechanism has a housing with a magnet and a rotating generally disc shaped member mounted therein. The magnet emits a magnetic flux and the rotating generally disc shaped member conducts the magnetic flux to provide a tension force opposite to the direction of rotation of the roll as it is unwound on the supply reel. The label removal device unwinds the web from the roll and removes the labels from the web. The label application device releasably retains the labels from the label removal device and applies the labels to the article. The take-up reel rewinds the web after the labels have been removed from the web.

In an alternative embodiment of the invention the core of the roll of labels has an inside surface with a predetermined inside diameter and the mounting mechanism of the label applicator also includes a supply reel shaft rotatably mounted to the magnetic tension control mechanism. The supply reel shaft has an outside surface with a predetermined outside diameter less than the inside diameter of the core and contains a keyway disposed on the outside surface. A tension bar is disposed within the keyway. The tension bar has a lower surface facing the keyway and an opposing upper surface. The upper surface has a rear portion and a tapered front portion extending downwardly from a distal end of the rear portion in the direction of the lower surface. A spring is engaged between the lower surface of the tension bar and the keyway to urge part of the upper surface of the tension bar above the outside surface of the supply reel shaft. When the core of the roll of labels is slid onto the supply reel shaft, the tapered front portion of the tension bar's upper surface engages the inside surface of the core to urge the tension bar downwardly until the core can be slid over the rear portion of the tension bar's upper surface.

In another alternative embodiment of the invention, the take-up reel of the label applicator includes a tension control mechanism having a motor operatively connected to a rotatable support shaft. The motor has a speed which varies with a load on the support shaft. A take-up reel shaft is concentrically mounted in fixed relation to the support shaft and rewinds the web thereon. When the motor drives the support shaft, a controlled tension force is applied to the web by the motor speed varying with the load.

### BRIEF DESCRIPTION OF THE DRAWINGS

FIG. 1 is a front view of a label applicator in accordance with the present invention.

FIG. 2 is a top view of the label applicator of FIG. 1.

FIG. 3 is a cross sectional view of the supply reel of the label applicator taken along the line 3-3 of FIG. 1.

FIG. 4 is a cross sectional view of the hysteresis type magnetic brake of FIG. 3 in a position of maximum torque.

FIG. 5 is a cross sectional view of the hysteresis type magnetic brake of FIG. 3 in a position of minimum torque.

FIG. 6 is a cross sectional view of a magnetic particle type magnetic brake in accordance with the present invention which is in a position of maximum torque.

FIG. 7 is a cross sectional view of the magnetic particle type magnetic brake of FIG. 6 in a position of minimum torque.

FIG. 8 is a cross sectional view of an eddy current type magnetic brake in accordance with the present invention which is in a position of maximum torque.

FIG. 9 is a cross sectional view of the eddy current type magnetic brake of FIG. 8 in a position of minimum torque.

FIG. 10 is a cross sectional view of the take-up reel of the label applicator taken along the line 10-10 of FIG. 1.

FIG. 11 is a side view schematic block diagram of the label application device taken along the line 11-11 of FIG. 1.

### DETAILED DESCRIPTION OF THE PREFERRED EMBODIMENTS

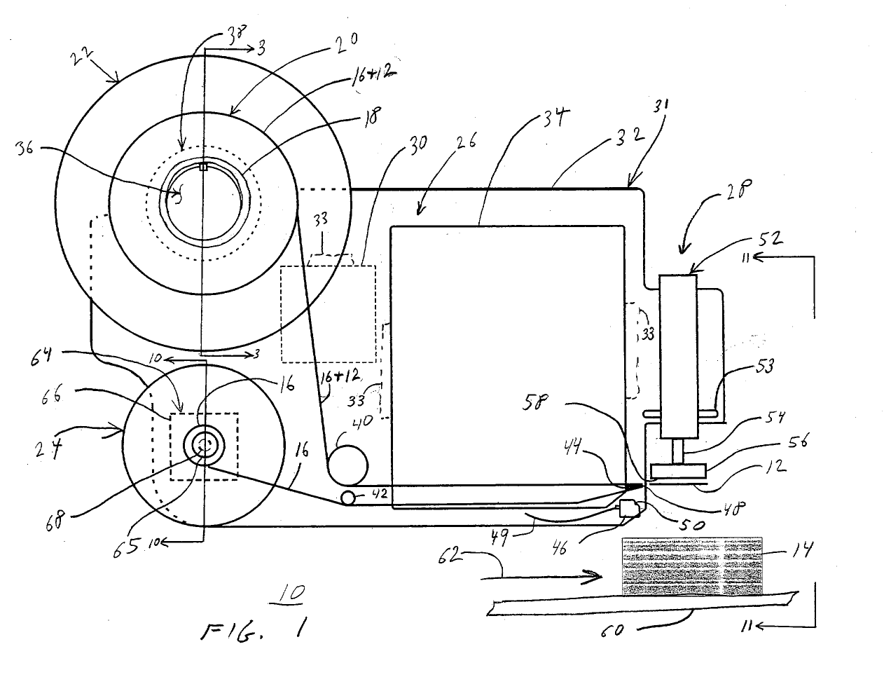

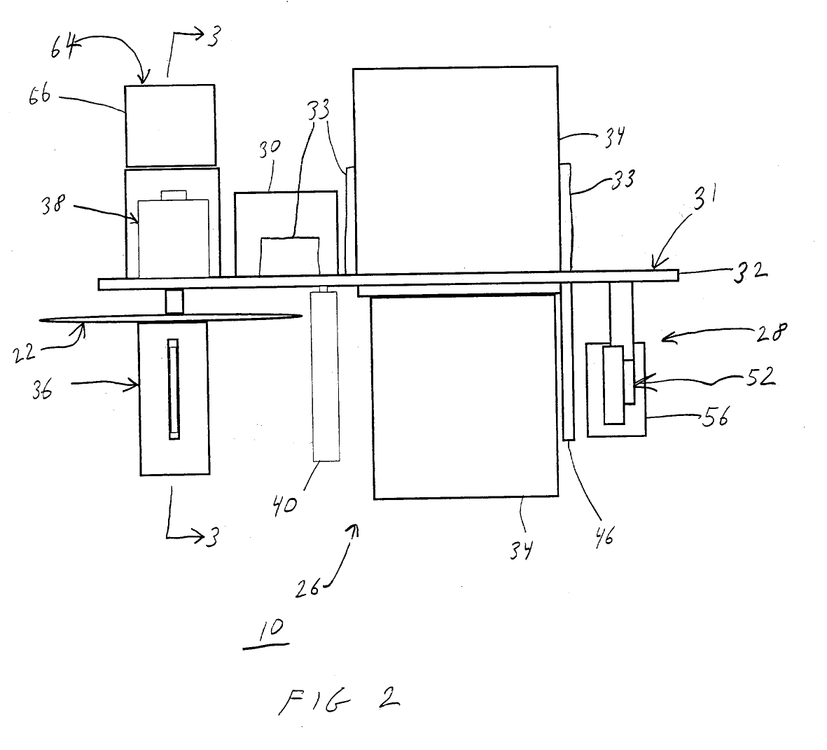

Referring to FIGS. 1 and 2, an exemplary embodiment of a label applicator 10 for applying labels 12 to an article 14 in accordance with the present invention is shown.

The labels 12 have one side coated with a pressure sensitive adhesive, and are carried on an elongated backing strip or web 16. The web 16 and labels 12 are wound around a core 18, e.g., a hollow cardboard cylinder, to form a roll of labels 20.

The label applicator 10 includes a supply reel 22, a take-up reel 24, a label removal device 26, a label application device 28 and a controller 30, all of which are mounted to a substantially planar support frame 31. In this embodiment the label removal device 26 of the label applicator 10 also includes a printer 34 to print onto the labels 12 before being applied to the article 14, and therefore is typically called a label printer/applicator.

The frame 31 further includes a substantially planar main frame 32 consisting of a single metal plate of substantially uniform thickness, and a plurality of mounting brackets 33. The mounting brackets 33, having substantially the same thickness as the main frame 32, project at substantially right angles from the main frame 32 and are welded thereto. The mounting brackets have a plurality of different lengths and orientations, e.g., vertical, horizontal or slanted, to provide support surfaces for the various components, e.g., the printer 34, the controller 30 or wires (not shown), of the label applicator 10.

During a labeling process the roll of labels 20 is mounted to the supply reel 22. The supply reel 22 includes a mounting mechanism 36 for releasably retaining the core of the roll, and a magnetic tension control mechanism 38 for applying tension to the web as the web is unwound from the roll by the label removal device 26. The mounting mechanism 36 is mounted on one side of the main frame 32 and the magnetic tension control mechanism 38 is mounted on the opposite side of the main frame 32 to simplify the overall design of the supply reel 22. As will be discussed in detail hereinafter, the magnetic tension control mechanism 38 has a magnet mounted on a rotating shaft to provide a tension force opposite to the direction of rotation of the roll 20 as it is unwound on the supply reel 22.

The label removal device includes intermediate rollers 40 and 42, printer 34, a peeler bar 44 and an air bar 46. The printer 34 pulls the web from the roll 20 on the supply reel 22, around intermediate roller 40 through the printer head (not shown) of the printer 34, over a peeling edge or tip 48 of the peeler bar 44, and feeds the web 16 to the take-up reel 24. The printer 34 receives print commands from the controller 30 to print various indicia or designs, e.g., bar codes, onto the labels 12 as they pass through. Though a variety of printers may be used with the label applicator 10, some preferred printers for this application are the models M-8485S, M-8490S, M-8459S and M-8460S print engines manufactured by SATO America, Inc. of Sunnyvale, Calif.

As the web is bent sharply around the peeling edge 48 of the peeler bar 44 the labels 12 are sequentially removed from the web 16 and directed toward the label application device 28. The air bar 46 is located generally underneath the peeler bar 44 and is connected to a supply of pressurized gas, e.g., air, (not shown) through air hose 49. The air bar 46 utilizes a blast of air through a plurality of orifices 50 (best seen in FIG. 11) to transfer the labels 12 to the label application device 28. In contrast to prior art air bars which utilize only a single orifice, the plurality of orifices 50 utilized in air bar 46 effects a smoother transfer of the label 12, with less possibility of damage or misalignment of the label 12.

The remaining web 16, which is left after the labels have been removed, is re-wound by the take-up reel 24. The take-up reel 24 includes a tension control mechanism 64 and a take-up reel shaft 65 for rewinding the web 16 thereon. As will be discussed in greater detail hereinafter, the tension control mechanism 64 has a motor 66 operatively connected to a rotatable support shaft 68, and the take-up reel shaft 65 is concentrically mounted in fixed relation to the support shaft 68. The motor 64 has a speed which varies with the changing load applied to the support shaft 68 as the web is rewound onto the take-up reel shaft 65 such that, when the motor 66 drives the support shaft 68, a controlled tension force is applied to the web 16 by the motor speed varying with the load.

The label application device 28 is designed for releasably retaining the labels 12 from the label removal device 26 and applying the labels 12 to the article 14. As will be discussed in greater detail hereinafter, the label application device 28 includes a piston assembly 52 having dual piston rods 54 with a generally rectangular foot block 56 mounted to their distal ends. The piston assembly is adjustably attached to frame 31 through an adjustment slot 53 (best seen in FIG. 11). The foot block 56 has a receiving face 58 with a plurality of orifices (not shown) through which vacuum pressure is applied to at least some of the orifices to releasably retain the labels 12 thereon. The labels 12 are generally transferred from the receiving face 58 to the article 14 by stamping the label 12 onto the article 14 or by blowing the label 12 onto the article 14, or by a combination of both methods.

Though the label application device is described in this embodiment as including a piston assembly, one skilled in the art would recognize that other label application devices may also be used. By way of example, a merging system can be used where the label 12 is extruded or peeled directly off the peeling edge 48, and wiped directly onto the article 14.

During a label application process the article 14 is moved through an appropriate position at a labeling station 60 as depicted by arrow 62. The article 14 is generally moved to the labeling station 62 using any suitable means. Preferably, a conveyor or other continuous delivery system is used, however one skilled in the art would recognize that manual methods may be used as well. The controller 30 of the label applicator 10 generally controls and monitors the functional parameters needed to effect the transfer of the labels 12 from the web 16 to the articles 14 at the labeling station 62.

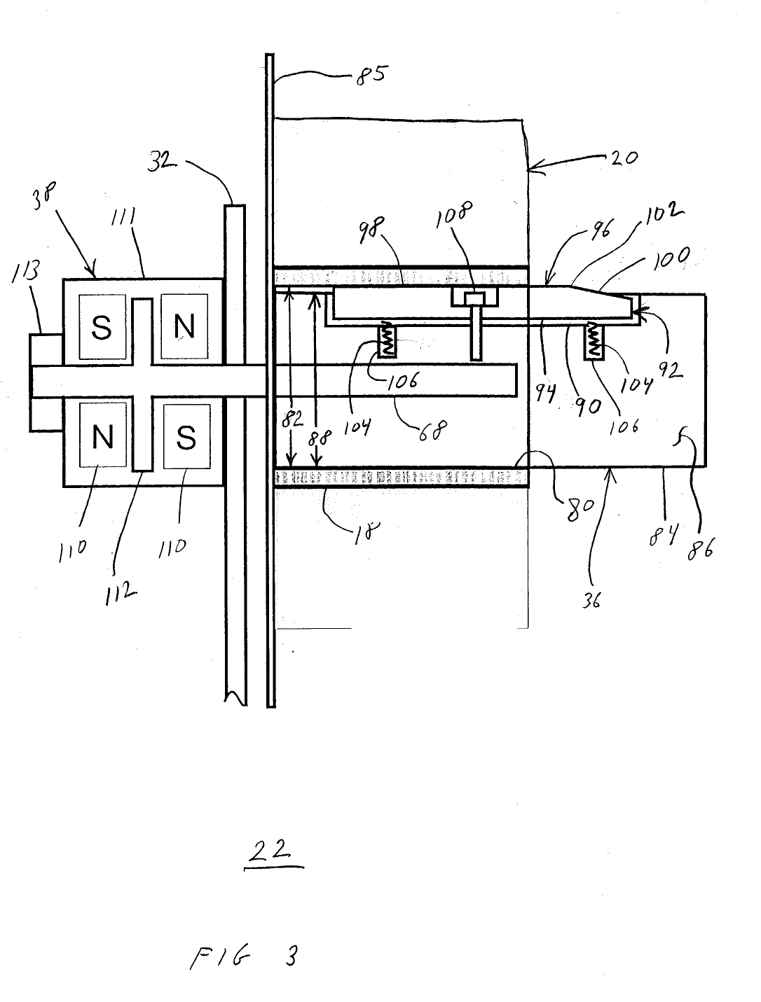

Referring to FIG. 3, the core 18 of the roll of labels 20 is illustrated having an inside surface 80 with a predetermined inside diameter 82. The mounting mechanism 36 of the supply reel 22 is shown in detail as including a supply reel shaft 84 rotatably mounted to the magnetic tension control mechanism 38, and rigidly connected to a generally disc shaped supply reel plate 85. The supply reel shaft 84 has an outside surface 86 with a predetermined outside diameter 88 less than the inside diameter 82 of the core 18. The supply reel shaft contains a keyway 90 disposed on its outside surface 86.

A tension bar 92 is disposed within the keyway 90. The tension bar 92 has a lower surface 94 which faces the keyway 90 and an opposing upper surface 96. The upper surface 96 has a rear portion 98 and a tapered front portion 100 extending downwardly from a distal end 102 of the rear portion 98 in the direction of the lower surface 94. A pair of springs 104 is engaged between the lower surface 94 of the tension bar 92 and the keyway 90, and are movably mounted into a pair of counter sunk spring mounting holes 106. The springs 104 urge the rear portion 98 of the upper surface 96 of the tension bar 92 above the outside surface 86 of the supply reel shaft 84. A counter sunk bolt 108 moveably retains the tension bar 92 within the keyway 90 and adjustably limits the distance above the outside surface 86 that the tension bar's 92 upper surface 96 may be urged.

During operation of the mounting mechanism 36, when the core 18 of the roll of labels 20 is slid onto the supply reel shaft 84, the tapered front portion 100 of the tension bar's 92 upper surface 96 engages the inside surface 80 of the core 18 to urge the tension bar 92 downwardly until the core 18 can be slid over the rear portion 96 of the tension bar's 92 upper surface 96. Advantageously, the mounting mechanism 36 provides firm support against the inside surface 80 of the core 18 and securely locks the core 18 so that it does not slip on the supply reel 22 while it is being unwound. Moreover, the mounting mechanism 36 allows the roll of labels 20 to be easily mounted and released during a labeling application process.

Though this embodiment describes a generally rectangular tension bar 92 urged upwardly by a pair of springs 104 and limited by a counter sunk bolt 108, one skilled in the art would recognize that other configurations and combinations of the above may also be used. By way of example, any number of springs may be used, the tension bar may have a cylindrical shape and the upper limit may be provided by other connectors such as rivets.

The magnetic tension control mechanism 38 includes a pair of multipole permanent magnets 110 mounted in a housing 111 on opposing sides of a rotating hysteresis disc 112 which is rotatably mounted to support shaft 68 to form a hysteresis type magnetic brake. The magnetic brake provides back torque with respect to rotational speed of the supply reel 22 as it unwinds. A torque adjustment knob at the rear of the housing enables the poles of the magnets to be adjusted and locked relative to each other in order to vary the amount of back torque applied.

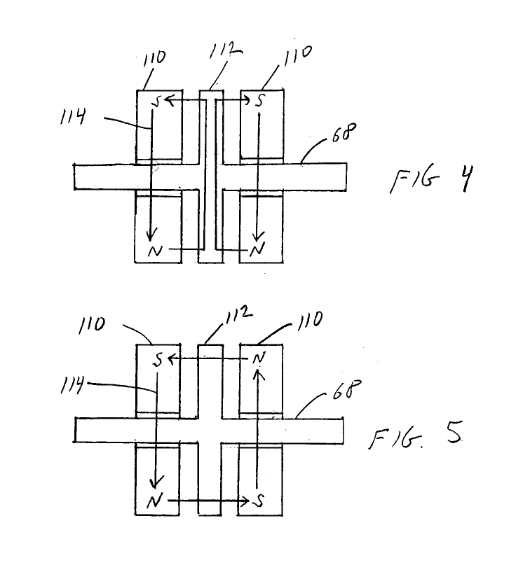

Referring to FIGS. 4 and 5, the hysteresis type magnetic brake of the magnetic tension control mechanism 38 utilizes the twin magnet 110 construction to control the strength of the magnetic field. When in the maximum position (as shown in FIG. 4), the similar magnetic poles are on opposite sides of the hysteresis disk 112. Magnetic lines of flux 114 are directed through the very narrow width of the hysteresis disk 112 which produces high magnetic field strength. In the minimum position (as shown in FIG. 5), the lines of flux 114 are not concentrated and field strengths are low.

As the hysteresis disk 112 rotates through the field established by alternating poles, the magnetic state of the disk 112 alternates. The resistance of the disk 112 to changing magnetic states produces a retarding force. This retarding force is converted to a smooth consistent torque substantially unaffected by speed.

Though this embodiment describes a magnetic tension control mechanism of the hysteresis type, one skilled in the art would recognize that other types of magnetic tension control mechanisms may also be used as well, e.g., magnetic particle type or eddy current type.

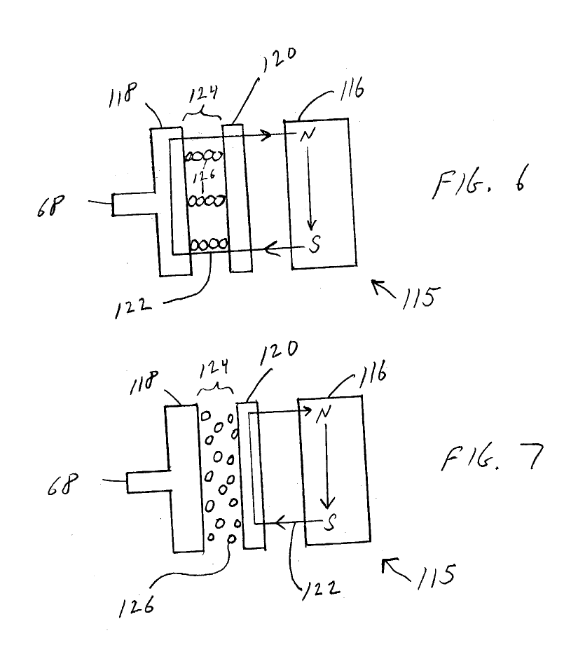

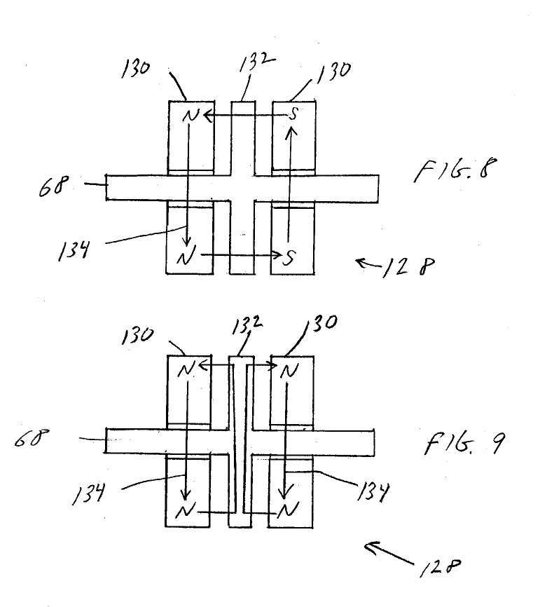

Referring to FIGS. 6 and 7, an embodiment of a magnetic particle type magnetic tension control mechanism 115 is presented, which utilizes a flux gate design. In this embodiment a multipole permanent magnet 116 is mounted in a housing (not shown) along with a rotating disc 118 and a flux gate 120. The space between the rotating disc 118 and the flux gate 120 is called a power gap 124 and is filled with magnetic particles 126. In the maximum position (as shown in FIG. 6), magnetic lines of flux 122 pass through the flux gate 120 and across the power gap 124. In the minimum position (as shown in FIG. 7), magnetic lines of flux 122 are “short-circuited” by the flux gate 120. When magnetic lines of flux 122 pass through the power gap 124, the magnetic particles 126 form chains between the flux gate 120 and the rotating disk 118. These chains produce a retarding force or torque that is substantially unaffected by speed.

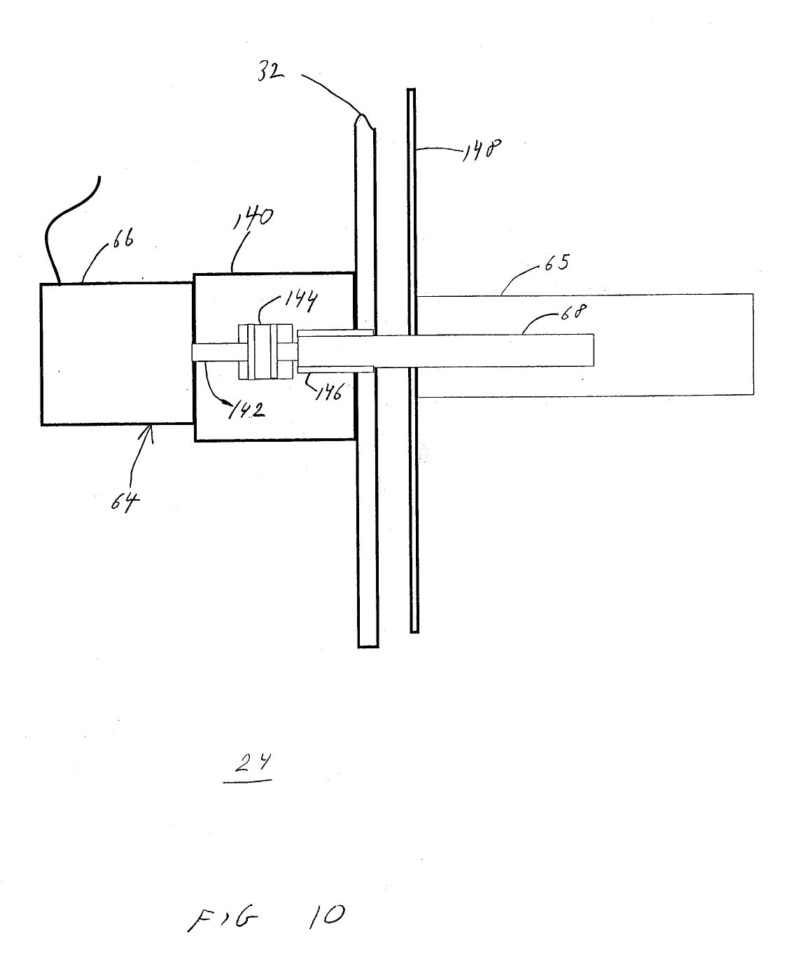

Referring to FIGS. 8 and 9, an embodiment of an eddy current type magnetic tension control mechanism 128 also utilizes a twin magnet 130 design. However, an eddy current disk 132 is used instead of a hysteresis disk. The maximum torque position for an eddy current type is opposite of a hysteresis type. More magnetic lines of flux exist when they go straight through the eddy current disk 132. Therefore, field strength is high when unlike poles are on opposite sides of the disk 132. Field strength is low when similar poles are opposite.

The eddy current type 128 behaves like a simple generator. When the disk 132 rotates through the alternating magnetic field, eddy currents are generated in the disk 132. The eddy currents produced are proportional to slip speed, hence, the torque produced is proportional to slip speed.

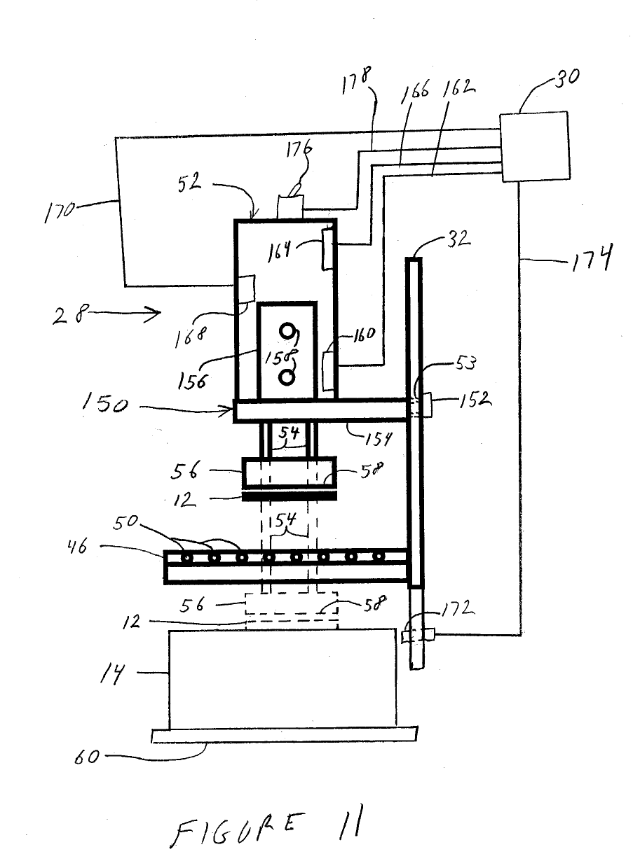

Referring to FIG. 10, the tension control mechanism 64 of the take-up reel 24 includes a non-synchronous, permanent split capacitor motor 66. The motor 66 is rigidly mounted to the frame 31 via motor housing 140. The motor 66 has a motor shaft 142 extending substantially along the same axis as the support shaft 68 and is directly coupled thereto via flexible coupling 144. The support shaft is rotatably mounted to support bearing 146, which is rigidly mounted to the frame 31. The take-up reel shaft 65 is rigidly connected to a generally disc shaped take-up reel plate 148.

During operation, the tension control mechanism has the dual roll of driving the take-up reel, as well as supplying tension control. In an attempt to accomplish this dual roll, prior art take-up reel tension control mechanisms designed the take-up reel shaft 65 to slip relative to the support shaft 68. In distinct contrast the take-up reel shaft 65 is concentrically mounted in fixed (non-slip) relation to the support shaft 68. The rotating speed of the motor shaft 142 of the non-synchronous motor 66 is designed to slip relative to the motor's well-known synchronous speed, in order to supply tension control. This provides a simpler, more reliable design, and allows the motor 66 to directly drive the support shaft 68.

The special non-synchronous permanent split capacitor design of the motor 66 allows the motor speed to vary with the load. When the take-up reel 24 is empty, motor 66 rotates at its highest speed, but does not require much torque. When the take-up reel 24 is full, the motor 66 rotates at low speed and requires more torque. The motor 66 can safely produce reverse torque while being back driven at any normal operating speed. Reverse torque will be approximately equal to stall torque. Maximum torque is produced at stall with less torque available as the motor 66 speeds up in the forward direction.

Alternatively, the drive motor 66 may be an AC torque motor. AC torque motors typically provide excellent performance for holding, winding and tensioning applications. Additionally, the reliability of these types of motors in tensioning applications is also excellent due to the reduced number of gears in the motor, which can wear over time as back tensioning is applied.

Referring to FIG. 11, the piston assembly 52 of the label application device 28 has the dual piston rods 54 with a foot block 56 mounted to the distal ends of the dual rods 54. The foot block 56 has a receiving face 58 with a plurality of orifices (not shown) through which vacuum pressure is applied to at least some of the orifices to releasably retain the labels 12 thereon. When the piston rods are fully retracted (as indicated in solid line form), the labels 12 are transferred to the foot block 56 by utilizing blasts of air directed through the plurality of orifices 50 of air bar 46. By utilizing a plurality of orifices 50, as opposed to a single orifice of prior art air bars, the labels are transferred more reliably, with less possibility of damage. When the piston rods are fully extended (as indicated in phantom form), the labels 12 are transferred to the package 14 located in the labeling station 60. The labels 12 are transferred from the receiving face 58 to the article 14 by stamping the label 12 onto the article 14 or by blowing the label 12 onto the article 14.

The piston assembly 52 is adjustably attached to adjustment slot 53 via an adjustable bracket 150, via connecting bolts 152. The bracket 150 includes a horizontal member 154 projecting substantially perpendicular from the main frame 32, and a vertical member 156 projecting upwardly from horizontal member 154. The vertical member 156 attaches to the piston assembly 52 via connecting bolts 158.

The label application device 28 of the label applicator 10 also includes a fully extended limit switch 160 to generate a “fully extended” signal indicative of the piston rod 54 being fully extended. The fully extended signal is transmitted to controller 30 through signal line 162. A fully retracted limit switch 164 generates a “fully retracted” signal indicative of the piston rod 54 being fully retracted, and transmits the fully retracted signal to the controller through signal line 166. For safety purposes, the application device 28 also includes a pressure sensor 168 for sensing pressure applied to the piston rod 54. The pressure sensor transmits a pressure signal indicative of the pressure on the piston rod 54 to the controller 30 via signal line 170. An article sensor 172 for sensing location of the article provides a start signal when the article 14 is located in the labeling station 60, which is transmitted to the controller 30 through sensing line 174.

In contrast to prior art label applicators, the label application device also includes a selector switch 176, which is manually operated between a first and second state. When the selector switch 176 is in the first state, the label application device 28 applies the labels 12 to the article 14 by blowing. When the selector switch 176 is in the second state the label application device 28 applies the labels 12 to the article 14 by stamping. The selector switch 176 transmits a “state” signal 178, indicative of whether the selector switch 176 is in the first or second state, to the controller 30 via signal line 178.

Though the various sensors are shown in this embodiment mounted in various fixed locations on the piston assembly 52 and main frame 32, one skilled in the art would recognize that the sensors may be mounted in other locations as well. By way of example, the article sensor 172 may be remotely mounted away from the frame 30 or the pressure sensor may be mounted in the foot block 56.

The controller 30 has a memory and an executable program for controlling and monitoring the functional parameters needed to print on the labels, to transfer the labels from the web to the label application device, and to transfer from the label application device to the article at the labeling station. When the controller 30 receives the start signal it generates a disable signal to disable the article sensor 172 and pressurizes the piston rods 54 to extend the piston rods 54 from the fully retracted position to the fully extended position. When the piston rods 54 contact the article 14, the label is applied to the article by blowing or stamping depending on the state of selector switch 176.

As a safety precaution, the pressure sensor 168 monitors the pressure applied to the piston rods 54 during this time. If the pressure signal reaches a predetermined threshold level, indicating that a foreign object (such as an operator's hand) is caught between the piston rod 54 and the article 14, than the controller 30 retracts the piston rods 54.

When the piston rod 54 is fully extended the fully extended limit switch 160 generates the fully extended signal to have the controller 30 retract the piston rod 54. The controller 30 than generates a print signal to command the printer 34 to print onto another label 12 only after the fully retracted signal has been generated by the fully retracted limit switch. Once the printing is complete, the controller generates an enable signal to re-enable the article sensor 172 and start the cycle over again.

In this way the controller 30 controls the timing between the printing of a label 120 and the extension of the piston rods 54 to prevent false triggering and jams. In contrast to prior art controllers, the piston rod 54 must be fully retracted before the controller 30 will issue a print command to initiate printing of a label, therefore preventing a potential jams during the application process.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A label applicator for applying labels to an article, the labels being carried on an elongated web wound around a core to form a roll of labels, the label applicator comprising:
a frame;
a supply reel mounted to the frame, the supply reel including
a mounting mechanism for releasably retaining the core of the roll, and
a magnetic tension control mechanism for applying tension to the web as the web is unwound from the roll, the magnetic tension control mechanism having a housing with a magnet and a rotating generally disc shaped member mounted therein, the magnet emitting a magnetic flux and the rotating generally disc shaped member conducting the magnetic flux to provide a tension force opposite to the direction of rotation of the roll as it is unwound on the supply reel;
a label removal device mounted to the frame for unwinding the web from the roll and removing the labels from the web;
a label application device for releasably retaining the labels from the label removal device and applying the labels to the article; and
a take-up reel mounted to the frame for rewinding the web after the labels have been removed from the web.

2. The label applicator of claim 1 wherein the core of the roll of labels has an inside surface with a predetermined inside diameter and wherein the mounting mechanism further comprises:
a supply reel shaft rotatably mounted to the magnetic tension control mechanism and having an outside surface with a predetermined outside diameter less than the inside diameter of the core, the supply reel shaft containing a keyway disposed on the outside surface;
a tension bar disposed within the keyway, the tension bar having a lower surface which faces the keyway and an opposing upper surface, the upper surface having a rear portion and a tapered front portion extending downwardly from a distal end of the rear portion in the direction of the lower surface; and
a spring engaged between the lower surface of the tension bar and the keyway to urge part of the upper surface of the tension bar above the outside surface of the supply reel shaft;
wherein when the core of the roll of labels is slid onto the supply reel shaft, the tapered front portion of the tension bar's upper surface engages the inside surface of the core to urge the tension bar downwardly until the core can be slid over the rear portion of the tension bar's upper surface.

3. The label applicator of claim 1 wherein the take-up reel further comprises:
a tension control mechanism having a motor operatively connected to a rotatable support shaft, the motor having a speed which varies with a load on the support shaft; and
a take-up reel shaft for rewinding the web thereon, the take-up reel shaft being concentrically mounted in fixed relation to the support shaft;
wherein, when the motor drives the support shaft, a controlled tension force is applied to the web by the motor speed varying with the load.

4. The label applicator of claim 1 wherein the label removal device further comprises an air bar having a plurality of orifices in fluid connection to a supply of pressurized gas, wherein blasts of the gas are distributed through the air bar and directed at the labels to assist in the transfer of the labels from the label removal device to the label application device.

5. The label applicator of claim 1 wherein the label application device further comprises a piston assembly having dual piston rods with a foot block mounted to the distal ends of the dual rods, the foot block having a receiving face with a plurality of orifices through which vacuum pressure is applied to at least some of the orifices to releasably retain the labels thereon.

6. The label applicator of claim 1 further comprising a printer.

7. The label applicator of claim 1 further comprising:
a printer;
a piston assembly having a piston rod with a foot block mounted to the distal end of the rod, the foot block having a receiving face with a plurality of orifices through which vacuum pressure is applied to at least some of the orifices to releasably retain a label transferred from the web to the foot block;
a fully extended limit switch to generate a fully extended signal indicative of the piston rod being fully extended;
a fully retracted limit switch to generate a fully retracted signal indicative of the piston rod being fully retracted;
a pressure sensor for sensing pressure applied to the piston rod to provide a pressure signal indicative of the pressure on the piston rod;
an article sensor for sensing location of the article to provide a start signal when the article is in a predetermined location; and
a controller responsive to the start signal and having,
a means for generating a disable signal to disable the article sensor,
a means for pressurizing the piston rod to extend the piston rod,
a means for applying the label to the article,
a means for retracting the piston rod if the pressure signal reaches a predetermined threshold level,
a means for retracting the piston rod when the fully extended signal is generated,
a means for generating a print signal to command the printer to print onto another label only after the fully retracted signal has been generated, and
a means for generating an enable signal to re-enable the article sensor.

8. The label applicator of claim 1 further comprising a selector switch manually operated between a first and second state, wherein the label application device applies the labels to the article by blowing when the selector switch is in the first state and by stamping when the selector switch is in second state.

9. The label applicator of claim 1 wherein the frame further comprises:
a substantially planar main frame consisting of a single metal plate of substantially uniform thickness; and
a plurality of mounting brackets projecting at substantially right angles from the main frame and welded thereto, the brackets having substantially the same thickness as the main frame.

10. The label applicator of claim 1 wherein the magnetic tension control mechanism further comprises a pair of magnets mounted in the housing on opposing sides of the rotating generally disc shaped member.

11. The label applicator of claim 1 wherein the magnetic tension control mechanism further comprises one of a hystersis type, an eddy current type and a magnetic particle type.

12. The label applicator of claim 1 wherein the magnetic tension control mechanism further comprises a flux gate and a plurality of magnetic particles mounted in the housing.

13. The label applicator of claim 3 wherein the motor of the take-up reel's tension control mechanism further comprises a non-synchronous, permanent split capacitor motor.

14. The label applicator of claim 3 wherein the motor of the take-up reel's tension control mechanism further comprises an AC torque motor.

15. The label applicator of claim 3 wherein the motor of the take-up reel's tension control mechanism further comprises a motor shaft extending substantially along the same axis as the support shaft and coupled thereto.

16. The label applicator of claim 9 wherein the mounting mechanism of the supply reel is mounted on one side of the main frame and the magnetic tension control mechanism is mounted on an opposite side of the main frame.

17. A label applicator for applying labels to an article, the labels being carried on an elongated web wound around a core to form a roll of labels, the core including an inside surface having a predetermined inside diameter, the label applicator comprising:
a frame;
a supply reel mounted to the frame, the supply reel including,
a tension control mechanism for applying tension to the web as the web is unwound from the roll, and
a mounting mechanism for releasably retaining the core of the roll, the mounting mechanism including,
a supply reel shaft rotatably mounted to the magnetic tension control mechanism and having an outside surface with a predetermined outside diameter less than the inside diameter of the core, the supply reel shaft containing a keyway disposed on the outside surface,
a tension bar disposed within the keyway, the tension bar having a lower surface which faces the keyway and an opposing upper surface, the upper surface having a rear portion and a tapered front portion extending downwardly from a distal end of the rear portion in the direction of the lower surface, and
a spring engaged between the lower surface of the tension bar and the keyway to urge part of the upper surface of the tension bar above the outside surface of the supply reel shaft,
wherein when the core of the roll of labels is slid onto the supply reel shaft, the tapered front portion of the tension bar's upper surface engages the inside surface of the core to urge the tension bar downwardly until the core can be slid over the rear portion of the tension bar's upper surface;
a label removal device mounted to the frame for unwinding the web from the roll and removing the labels from the web;
a label application device for releasably retaining the labels from the label removal device and applying the labels to the article; and
a take-up reel mounted to the frame for rewinding the web after the labels have been removed from the web

18. The label applicator of claim 17 wherein the take-up reel further comprises:
a tension control mechanism having a motor operatively connected to a rotatable support shaft, the motor having a speed which varies with a load on the support shaft; and
a take-up reel shaft for rewinding the web thereon, the take-up reel shaft being concentrically mounted in fixed relation to the support shaft;
wherein, when the motor drives the support shaft, a controlled tension force is applied to the web by the motor speed varying with the load.

19. The label applicator of claim 17 wherein the label removal device further comprises an air bar having a plurality of orifices in fluid connection to a supply of pressurized gas, wherein blasts of the gas are distributed through the air bar and directed at the labels to assist in the transfer of the labels from the label removal device to the label application device.

20. The label applicator of claim17 further comprising a selector switch manually operated between a first and second state, wherein the label application device applies the labels to the article by blowing when the selector switch is in the first state and by stamping when the selector switch is in second state.

21. The label applicator of claim 18 wherein the motor of the take-up reel's tension control mechanism further comprises a non-synchronous, permanent split capacitor motor.

22. The label applicator of claim 18 wherein the motor of the take-up reel's tension control mechanism further comprises a motor shaft extending substantially along the same axis as the support shaft and coupled thereto.

23. The label applicator of claim 17 further comprising a printer.

24. A label applicator for applying labels to an article, the labels being carried on an elongated web wound around a core to form a roll of labels, the label applicator comprising:
a frame;
a supply reel mounted to the frame, the supply reel including
a mounting mechanism for releasably retaining the core of the roll, and
a tension control mechanism for applying tension to the web as the web is unwound from the roll;
a label removal device mounted to the frame for unwinding the web from the roll and removing the labels from the web;
a label application device for releasably retaining the labels from the label removal device and applying the labels to the article; and
a take-up reel mounted to the frame for rewinding the web after the labels have been removed from the web, the take-up reel including,
a tension control mechanism having a motor operatively connected to a rotatable support shaft, the motor having a speed which varies with a load on the support shaft, and
a take-up reel shaft for rewinding the web thereon, the take-up reel shaft being concentrically mounted in fixed relation to the support shaft,
wherein, when the motor drives the support shaft, a controlled tension force is applied to the web by the motor speed varying with the load.

25. The label applicator of claim 24 further comprising a printer.

26. A label applicator for applying labels to an article, the labels being carried on an elongated web wound around a core to form a roll of labels, the label applicator comprising:
a frame having a substantially planar main frame;
a supply reel mounted to the frame, the supply reel including
a mounting mechanism mounted to one side of the planar main frame for releasably retaining the core of the roll, and
a tension control mechanism mounted to an opposite side of the planar main frame for applying tension to the web as the web is unwound from the roll;
a label removal device mounted to the frame for unwinding the web from the roll and removing the labels from the web;
a label application device for releasably retaining the labels from the label removal device and applying the labels to the article; and
a take-up reel mounted to the frame for rewinding the web after the labels have been removed from the web.

27. The label applicator of claim 26 further comprising:
the substantially planar main frame consisting of a single metal plate of substantially uniform thickness; and
a plurality of mounting brackets projecting at substantially right angles from the main frame and welded thereto, the brackets having substantially the same thickness as the main frame.

28. A label applicator for applying labels to an article, the label applicator comprising:
a printer;
a piston assembly having a piston rod with a foot block mounted to the distal end of the rod, the foot block having a receiving face with a plurality of orifices through which vacuum pressure is applied to at least some of the orifices to releasably retain a label to the foot block;
a fully extended limit switch to generate a fully extended signal indicative of the piston rod being fully extended;
a fully retracted limit switch to generate a fully retracted signal indicative of the piston rod being fully retracted;
a pressure sensor for sensing pressure applied to the piston rod to provide a pressure signal indicative of the pressure on the piston rod;
an article sensor for sensing location of the article to provide a start signal when the article is in a predetermined location; and
a controller responsive to the start signal and having,
a means for generating a disable signal to disable the article sensor,
a means for pressurizing the piston rod to extend the piston rod,
a means for applying the label to the article,
a means for retracting the piston rod if the pressure signal reaches a predetermined threshold level,
a means for retracting the piston rod when the fully extended signal is generated,
a means for generating a print signal to command the printer to print onto another label only after the fully retracted signal has been generated, and
a means for generating an enable signal to re-enable the article sensor.
